(19) United States
(12) Patent Application Publication
(10) Pub. No.: US 2017/0172840 A1
(43) Pub. Date: Jun. 22, 2017

(54) APPARATUS FOR PARTIALLY ENCLOSING A ROTATABLE SPHERICAL OBJECT

(71) Applicant: GEMI TOOLS, LLC, Sandy, UT (US)

(72) Inventor: Jay B. McCleary, West Valley City, UT (US)

(21) Appl. No.: 15/383,895

(22) Filed: Dec. 19, 2016

Related U.S. Application Data
(60) Provisional application No. 62/269,788, filed on Dec. 18, 2015.

(51) Int. Cl. A61H 15/00

(52) U.S. Cl. CPC A61H 15/00; A61H 2015/0042

(57) ABSTRACT

Apparatuses, such as massage rollers, for partially enclosing a rotatable spherical object are disclosed herein. A massage roller may include a housing formed from a base and cap that, when coupled together, partially enclose a spherical object. The spherical object, such as a stone, of the massage roller may be rubbed on an individual to provide a massage. As the massage roller is rubbed onto the individual, the spherical object may rotate within the housing.

### RELATED APPLICATION

This application claims priority to U.S. Patent Application No. 62/269,788, filed on Dec. 18, 2015 which is incorporated by reference in its entirety.

### TECHNICAL FIELD

The present disclosure relates generally to apparatuses for at least partially enclosing a rotatable spherical object, along with related methods and kits.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A is an embodiment of a cross-sectional view of a massage roller.

FIG. 1B is an alternative embodiment of a cross-sectional view of a massage roller.

FIG. 2 is an embodiment of massage roller components in an unassembled state.

FIG. 3 illustrates the massage roller components of FIG. 2 in an unassembled state.

FIG. 4 is a perspective view of the massage roller of FIG. 2 in an assembled state.

FIG. 5 illustrates the massage roller of FIG. 2 held by a user.

FIG. 6 illustrates a side view of an alternative embodiment of a massage roller.

FIG. 7 illustrates a perspective view of the massage roller of FIG. 6 in an assembled state.

FIG. 8 illustrates a perspective view of the massage roller of FIG. 6 in a disassembled state.

FIG. 9 illustrates a side view of an alternative embodiment of a massage roller.

FIG. 10 illustrates a plan view of the massage roller of FIG. 9.

FIG. 11 illustrates a perspective view of the massage roller of FIG. 9.

### DETAILED DESCRIPTION

The present disclosure relates generally to apparatuses for at least partially enclosing a rotatable spherical object, along with related methods and kits. For example, some embodiments disclosed herein are massage rollers configured to partially enclose a spherical object, such as a polished stone.

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is used its ordinary sense, and is broad enough to refer to any suitable coupling or other form of interaction between two or more entities, including mechanical, fluid and thermal interaction. Two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., an adhesive). The term “massage roller” refers broadly to any roller designed to roll across the surface of an individual, such as rollers designed to provide a massage or otherwise improve the subjective well-being of an individual.

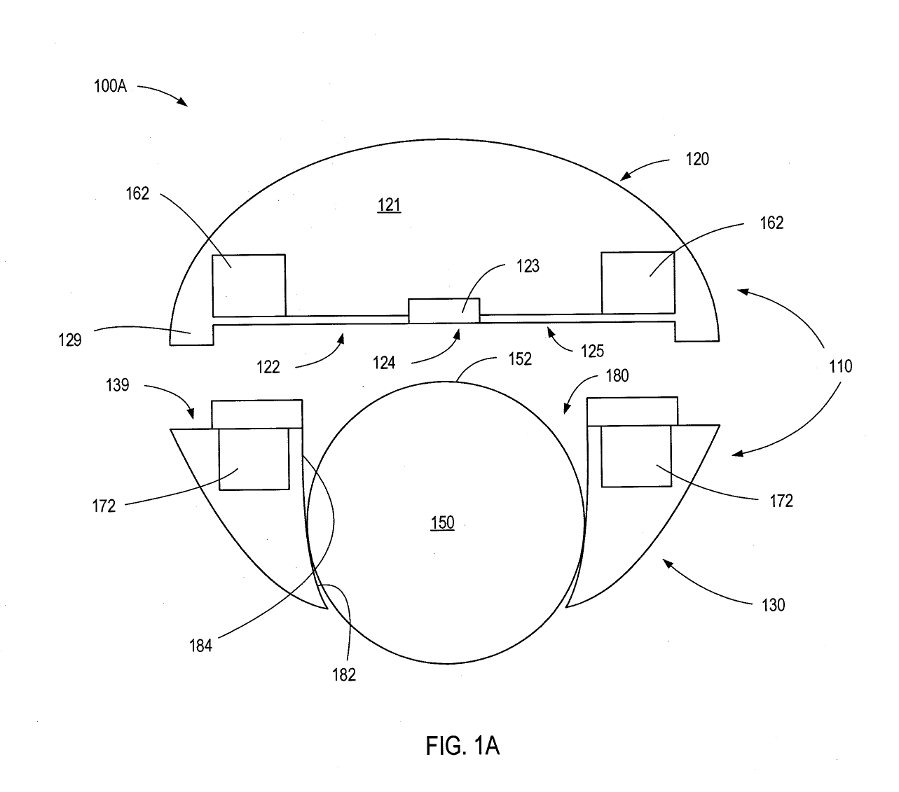

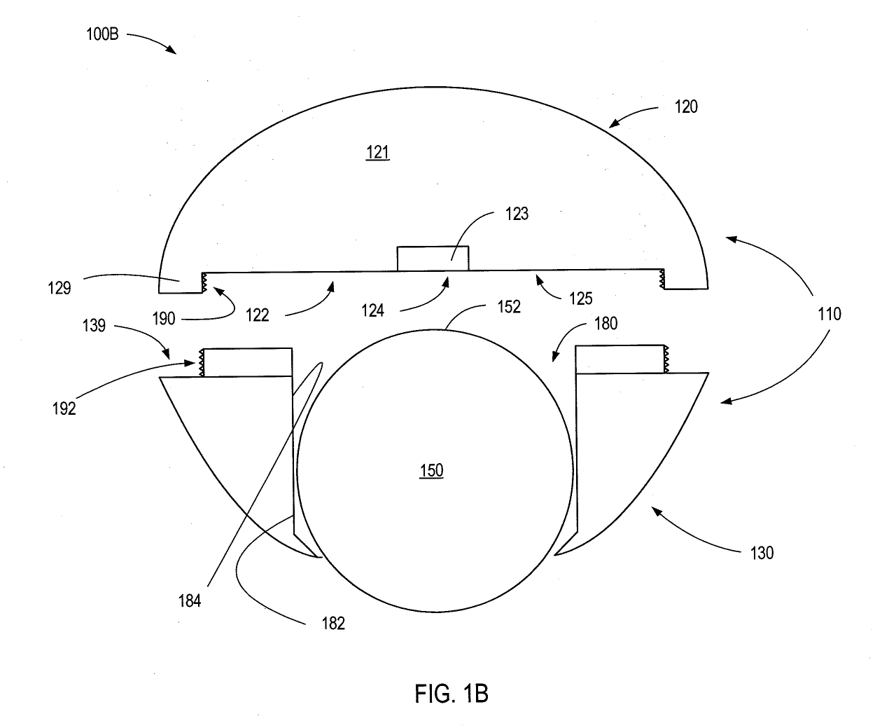

FIG. 1A provides an exploded cross-sectional schematic view of a massage roller 100. As depicted in FIG. 1A, the massage roller 100 may include a housing 110 that is configured to partially enclose a spherical object 150 (e.g., a stone). The housing 110 may include a base 120 and a cap 130.

In some embodiments, the base 120 includes a first surface 121 (e.g., a bowl-shaped or convex surface) on a first side of the base 120 and a second surface 122 (e.g., a flat surface) on a second (e.g., opposite) side of the base 120. The base 120 may be formed from any suitable material. For example, in some embodiments, the base 120 includes (e.g., is made primarily from) wood.

In some embodiments, the base 120 includes a piece of material 123 that forms a low-friction surface 124. The low-friction surface 124 may be a portion of the second surface 122. Stated differently, the second surface 122 may include an inner portion (e.g., low-friction surface 124) and an outer portion 125 (e.g., a high-friction surface). The inner portion (e.g., low-friction surface 124) may form a lower static coefficient of friction with the spherical object 150 than the static coefficient of friction between the spherical object 150 and the outer portion 125 of the second surface 122. In some embodiments (e.g., using teflon) the low-friction surface 124 may be configured to contact the spherical object 150 at a single point 152 on the spherical object 150 when the spherical object 150 is partially enclosed within the housing 110. Stated differently, in some embodiments, at any single moment, the spherical object 150 may contact the low-friction surface 124 of the base 120 at only a single point 152.

In some embodiments, the base 120 may be shaped to include one or more mating elements designed to mate with corresponding mating elements of the cap. For example, in the depicted embodiment, the base 120 include an annular protrusion 129 that is shaped to mate with a corresponding annular groove 139 on the cap 130.

The cap 130 may be made from any suitable material. For example, in some embodiments, the cap 130 includes (e.g., is primarily made from) wood. The cap 130 may include an outer convex surface.

As shown in FIG. 1A, the cap 130 may include a channel 180 that extends through an entirety of the cap 130. The channel 180 may include a first portion 182 having a first diameter that is less than the diameter of the spherical object 150 and a second portion 184 that has a second diameter that is greater than the diameter of the spherical object 150. In some embodiments, the spherical object 150 has a diameter of between 0.5 and 2.0 inches, between 0.75 and 1.5 inches, and/or between 1.0 and 1.4 inches. In the depicted embodiment, the first portion 182 of the channel 180 is disposed further from the low-friction surface 124 of the base 120 than the second portion 184 of the channel 180. The first portion 182 of the channel 180 may be disposed a distance from the low-friction surface 124 of the base 120 that is less than the diameter of the spherical object 150. Due to the narrowness of the second portion 184 of the channel 180, the massage roller 100, when fully assembled (e.g., with the base 120 coupled to the cap 130 and the spherical object 150 partially enclosed within the housing 110) is configured such that the spherical object 150 remains disposed within the housing 110 as the housing 110 is transitioned from a configuration in which the cap 130 is disposed above the base 120 to a configuration in which the base 120 is disposed above the cap 130.

In some embodiments, the cap 130 is removably coupled to the base 120. For example, in some embodiments, the base 120 may include one or more magnets 162 and the cap 130 may include one or more magnets 172. The massage roller 100 may be configured such that when the base 120 and the cap 130 are properly aligned, the magnets 162 of the base 120 and the magnets 172 of the cap 130 provide an attractive magnetic force that couples the cap 130 to the base 120. In some embodiments, the one or more magnets 162, 172 of the base 120 and the cap 130 may include one or more strong permanent magnets, such as rare-earth magnets. Such strong permanent magnets may provide a sufficiently strong attractive force between the base 120 and the cap 130 to hold the housing 110 together during normal use. For example, the magnets 162, 172 may be strong enough to ensure that the base 120 remains coupled to the cap 130 as the assembled massage roller 100 transitions from a configuration in which the cap 130 is disposed above the base 120 to a configuration in which the base 120 is disposed above the cap 130. When assembled, the massage roller 100 may be configured to permit rotation of the spherical object 150 about a plurality of rotational axes while the spherical object 150 is partially enclosed within the housing 110.

One of ordinary skill in the art, with the benefit of this disclosure, will recognize that other coupling mechanisms (e.g., non-magnetic, mechanical coupling) may be used to selectively and removably couple the cap 130 to the base 120. For example, the mechanical coupling may include threads on the cap 130 and base 120 to allow suitable engagement. Alternatively, the cap 130 and base 120 may engage one another through a press fit.

While FIG. 1A depicts a massage roller 100 with a cap 130 that is selectively and removably coupled to the base 120, other embodiments are also within the scope of this disclosure. For example, in some embodiments, the cap 130 may be fixedly coupled to the base 120. More specifically, in some embodiments, the cap 130 may be fixedly coupled to the base 120 via an adhesive. A massage roller 100 with a base 120 and a cap 130 that are coupled to one another via an adhesive may be manufactured by placing the spherical object 150 between the base 120 and the cap 130 and then attaching the base 120 to the cap 130 via an adhesive.

Methods of using a massage roller are also disclosed herein. For example, some methods may include the step of obtaining a massage roller, such as the massage roller 100. The method may further include the step of rubbing the spherical object 150 of the massage roller 100 on the surface of a mammal (e.g., a human) while grasping the housing 110 of the massage roller 100 in a single hand. As the spherical object 150 is rubbed on the surface of the mammal, the spherical object 150 may rotate within the housing 110. In this manner (by rubbing the spherical object 150 on the mammal), the mammal may be massaged.

Kits are also disclosed herein. For example, a kit may include a housing, such as the housing 110 described herein. The kit may further include one or more spherical stones 150 (e.g., gemstones). In some embodiments, the kit may further include a pouch for holding a plurality of spherical stones and/or the housing 110. Thus, the housing 110 may be suitable to accommodate a desired gemstone at any given time.

FIG. 1B illustrates a massager roller 100B similar to the massage roller 100A illustrated in FIG. 1A. Like elements are illustrated with the same numbering. The massage roller 100B differs in that magnets are not used for coupling. Instead, the base 120 and the cap 130 are configured with corresponding threads 190, 192 to enable threadable engagement. The threads 190, 192 extend around an interior surface where the base 120 and cap 130 physically contact one another to enable removable engagement.

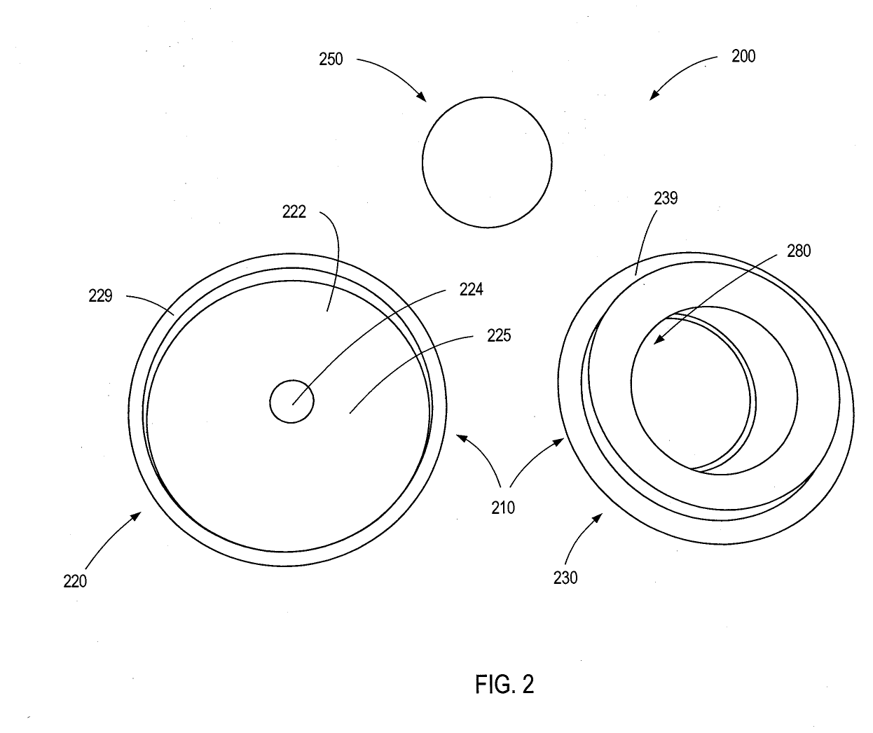

FIGS. 2-5 illustrate a massage roller 200 that resembles the massage roller 100 described above. Accordingly, like features are designed with like reference numerals, with the leading digits incremented to “2.”

FIG. 2 illustrates the massage roller 200 in an unassembled state with a two part housing 210, base 220, cap 230, second flat surface 222, low-friction surface 224, outer portion 225, annular protrusion 229, annular groove 239, spherical object 250, and channel 280.

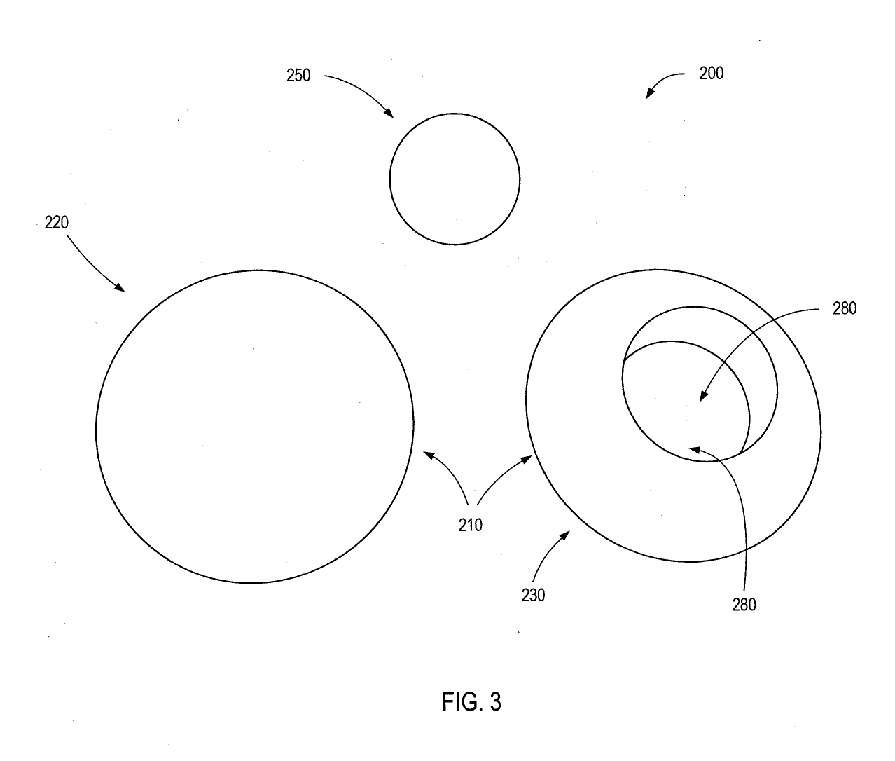

FIG. 3 illustrates the massage roller 200 in another unassembled state showing the opposite side of the base 220 with a first convex surface and the cap 230 with the outer convex surface.

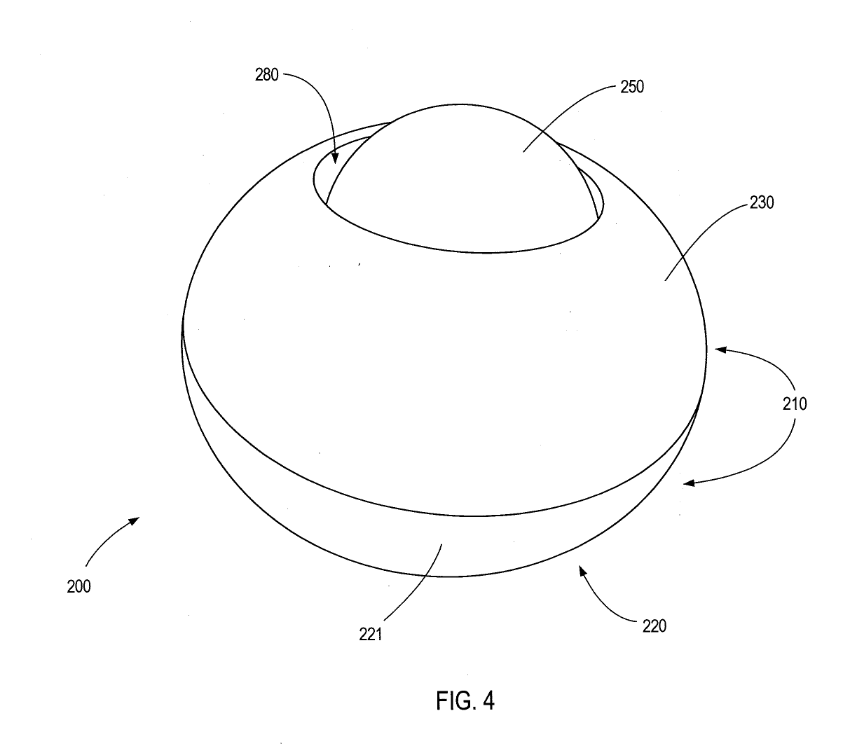

FIG. 4 illustrates the massage roller 200 in an assembled state with the base 220 disposed below the cap 230.

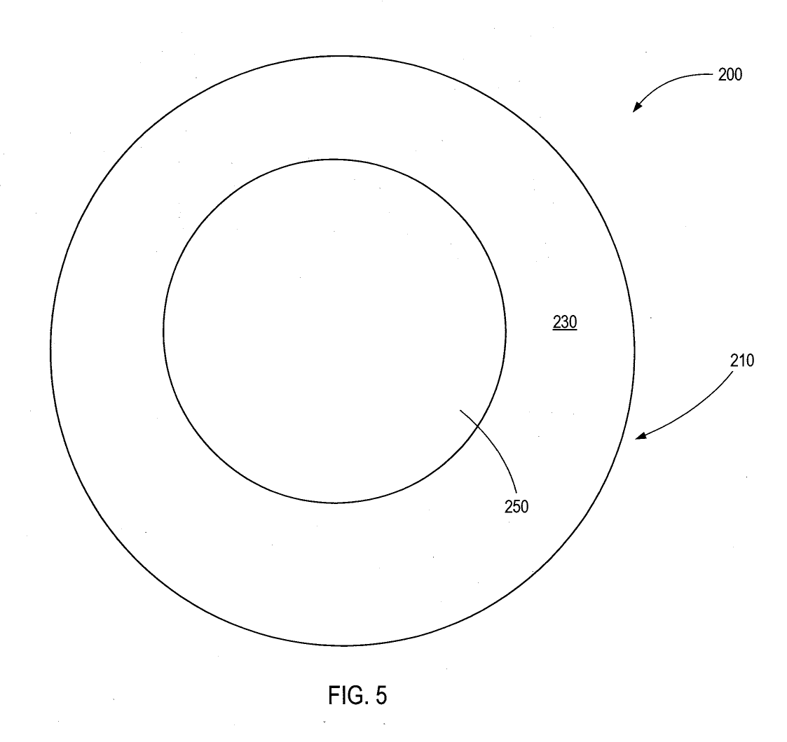

FIG. 5 illustrates the massage roller 200 in an assembled state with the cap 230 disposed below the base 220. As depicted in FIG. 5, the massage roller 200 is sized to be grasped in the palm of a human hand for ergonomic use.

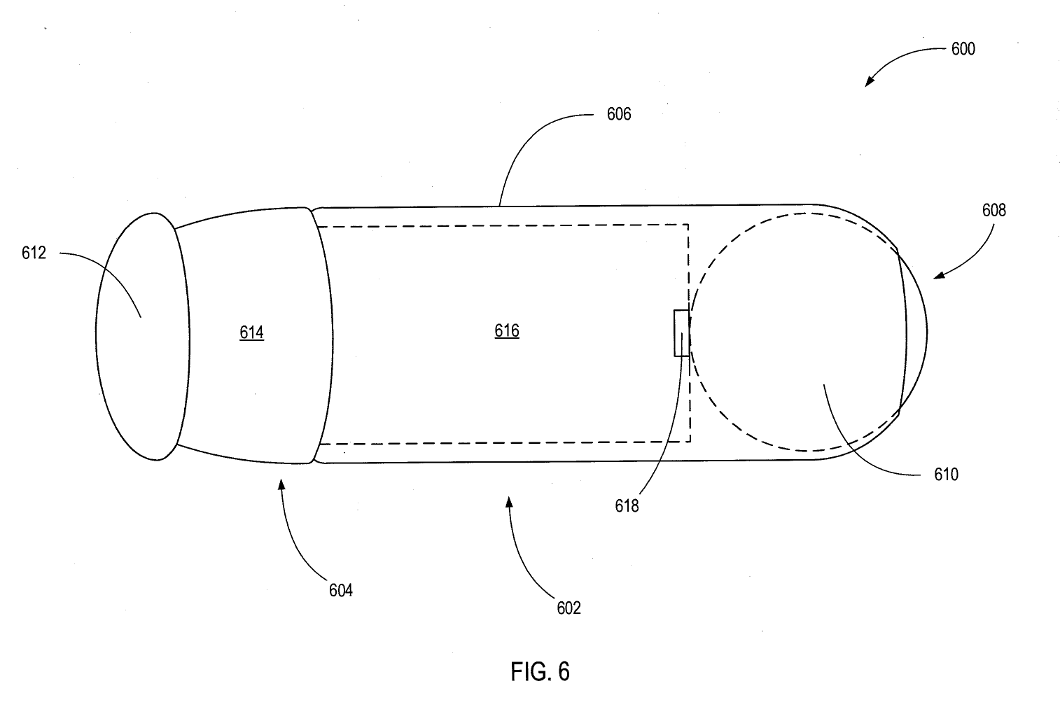

FIG. 6 illustrates a side view of an alternative embodiment of a massage roller 600. The massage roller 600 includes a housing 602, with a base 604 and cap 606 with an aperture 608. The cap 606 partially encloses a spherical object 610 with the spherical object 610 extending through the aperture 608. The base 602 includes a grip 612 that is received in a user's palm. The grip 612 is coupled to a support body 614 which is, in turn, coupled to a pedestal 616. In an assembled configuration, the pedestal 616 extends into an interior of the cap 606 and engages and supports the spherical object 610.

The pedestal 616 may include a low-friction surface 618, similar to surface 124, to contact the spherical object 610 at a single point in an assembled configuration. As shown, the cap 606 rests against the support body 614. Similar to previous embodiments, the cap 606 and the base 604 may be coupled to one another through magnetic interface, mechanical threads, or press fit. As such, the base 604 may be shaped to include one or more mating elements designed to mate with corresponding mating elements of the cap 606. The base 604 may include an annular protrusion that is shaped to mate with a corresponding annular groove on the cap 606. Alternatively, the annular protrusion may be coupled to the cap 606 and the annular groove may be disposed on the base 604.

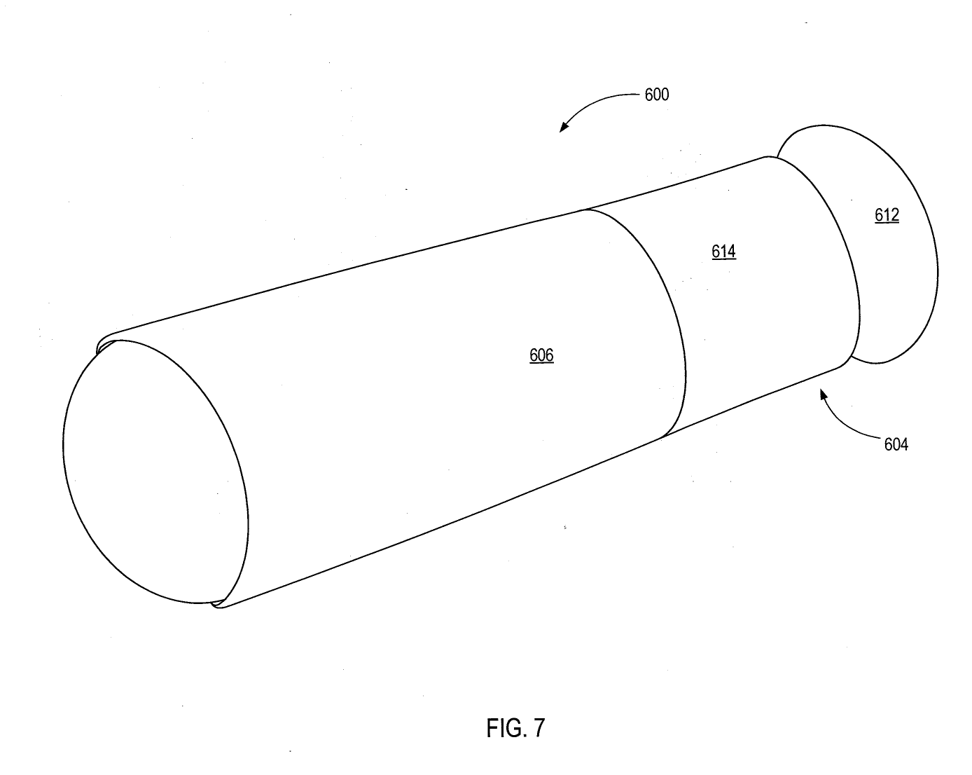

Referring to FIG. 7, a perspective view of a massager roller 600 of FIG. 6 is shown in an assembled configuration.

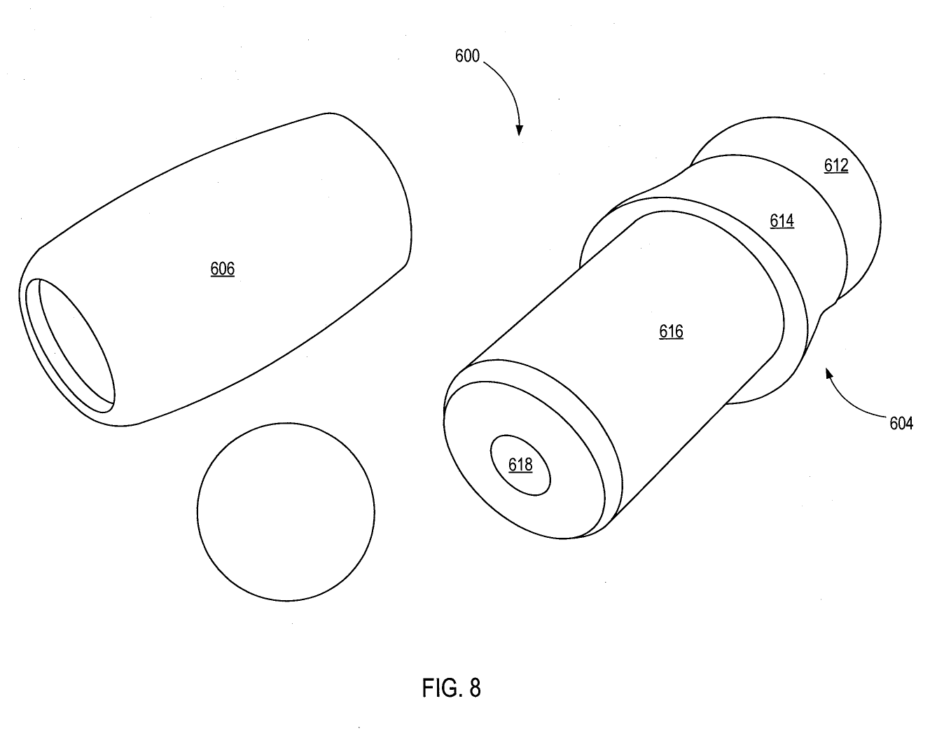

Referring to FIG. 8, a perspective view of a massage roller 600 of FIG. 6 is shown in a disassembled configuration.

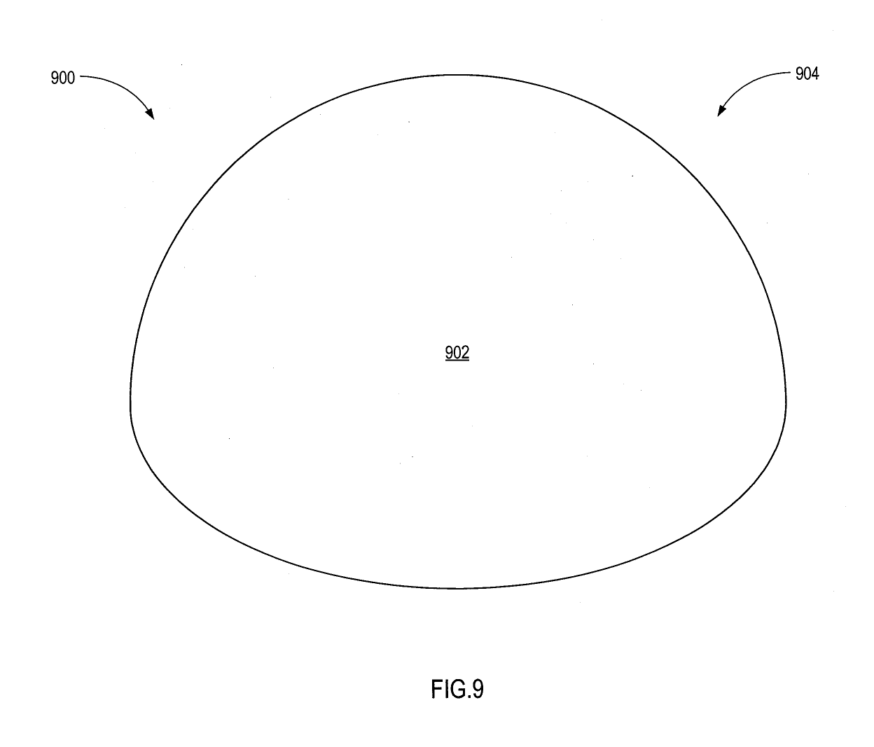

Referring to FIG. 9, a perspective view of an alternative embodiment of a massage roller 900 is shown. The massage roller 900 includes a base 902 that includes a first surface 904 (e.g., a bowl-shaped or convex surface) on the base 902. The base 902 may be formed from any suitable material. For example, in some embodiments, the base 902 includes (e.g., is made primarily from) wood.

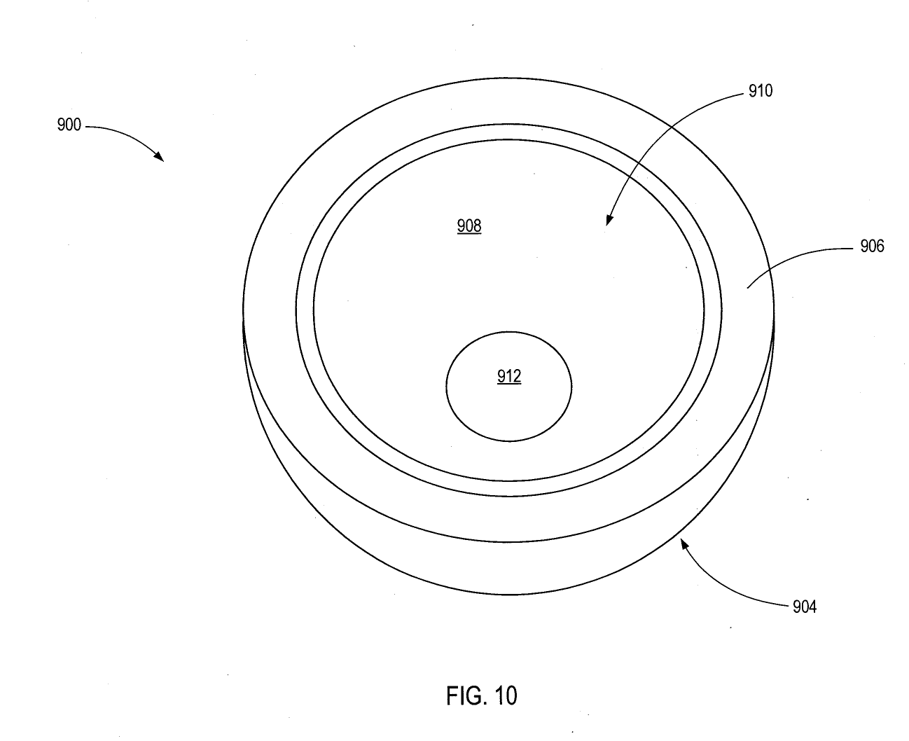

Referring to FIG. 10, an alternative perspective view of the massage roller 900 is shown. The massage roller 900 includes a substantially flat rim 906 that extends around a concave surface 908. The concave surface 908 defines an interior 910 to at least partially receive a spherical object. In some embodiments, the massage roller 900 includes a low-friction surface 912 disposed within the concave surface 908. The low-friction surface provides a lower static coefficient of friction with the spherical object than the static coefficient of friction between the spherical object and the remainder of the concave surface 908. The low-friction surface 912 may be configured to contact the spherical object at a single point on the spherical object when the spherical object is partially received within the interior 910.

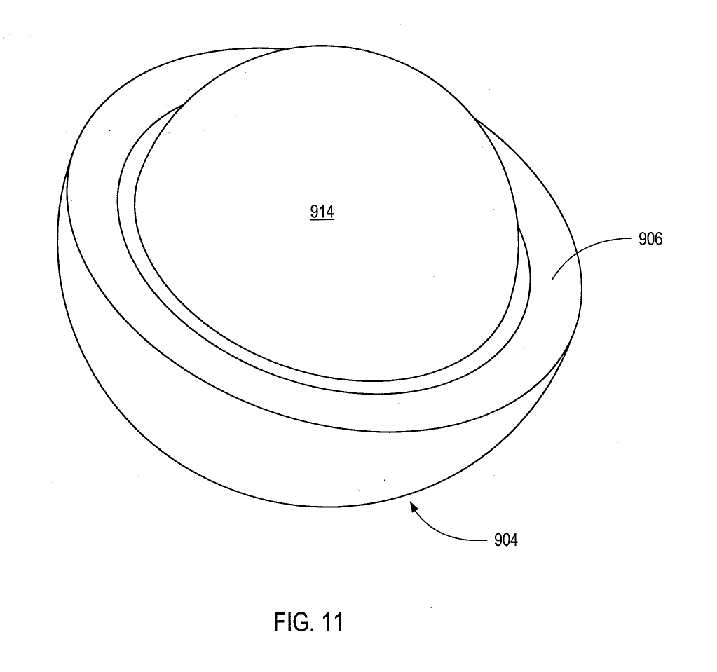

Referring to FIG. 11, a perspective view of the massage roller 900 with a spherical object 914 disposed within the interior 910. In use, the spherical object 914 is maintained within the interior 910 by pressing the base 902 and spherical object 914 against a body.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. A massage roller, the massage roller comprising:
a housing for partially enclosing a spherical object, the housing comprising:
a base comprising a surface for contacting the spherical object; and
a cap removably coupled to the base, the cap comprising a channel that extends through an entirety of the cap and receives the spherical object, wherein the channel comprises:
a first diameter less than the diameter of the spherical object to thereby retain the spherical object, and
a second diameter greater than the diameter of the spherical object to enable entry of the spherical object,
wherein the first portion of the channel is disposed further from the surface of the base than the second portion of the channel when the cap is coupled to the base.

2. The massage roller of claim 1, wherein the base includes a first convex surface and a second, substantially flat, surface.

3. The massage roller of claim 2, wherein the second surface includes a low-friction surface to contact the spherical object.

4. The massage roller of claim 3, wherein the low-friction surface includes teflon.

5. The massage roller of claim 1, wherein the base includes an annular protrusion and the cap includes an annular groove configured to mate with the annular protrusion.

6. The massage roller of claim 4, wherein the annular protrusion surrounds the majority of the second surface.

7. The massage roller of claim 1, wherein the base includes a base magnet and the cap includes a cap magnet to magnetically couple the base to the cap.

8. The massage roller of claim 1, wherein the cap includes a convex outer surface.

9. The massage roller of claim 1, further comprising an adhesive to couple the base to the cap.

10. The massage roller of claim 1, wherein the base and the cap each include threads to enable removable, threadable engagement with one another.

11. A massage roller, the massage roller comprising:
a spherical object; and
a housing for partially enclosing the spherical object, the housing comprising:
a base comprising a surface for contacting the spherical object; and
a cap removably coupled to the base, the cap comprising a channel that extends through an entirety of the cap and at least partially receives the spherical object, wherein the channel comprises:
a first diameter less than the diameter of the spherical object to thereby retain the spherical object while a portion of the spherical object protrudes from the channel, and
a second diameter greater than the diameter of the spherical object to enable entry of the spherical object,
wherein the first diameter of the channel is disposed further from the surface of the base than the second diameter of the channel when the cap is coupled to the base.

12. The massage roller of claim 11, wherein the base includes a first convex surface and a second, substantially flat, surface.

13. The massage roller of claim 12, wherein the second surface includes a low-friction surface to contact the spherical object.

14. The massage roller of claim 13, wherein the low-friction surface includes teflon.

15. The massage roller of claim 11, wherein the base includes an annular protrusion and the cap includes an annular groove configured to mate with the annular protrusion.

16. The massage roller of claim 15, wherein the annular protrusion surrounds the majority of the second surface.

17. The massage roller of claim 11, wherein the base includes a base magnet and the cap includes a cap magnet to magnetically couple the base to the cap.

18. The massage roller of claim 11, wherein the cap includes a convex outer surface.

19. The massage roller of claim 11, further comprising an adhesive to couple the base to the cap.

20. The massage roller of claim 11, wherein the base and the cap each include threads to enable removable, threadable engagement with one another.
